(19) United States
(12) Patent Application Publication
(10) Pub. No.: US 2026/0052553 A1
(43) Pub. Date: Feb. 19, 2026

(54) PHYSICAL DOWNLINK CONTROL CHANNEL SKIP INACTIVITY TIMER FOR RESUMING PHYSICAL DOWNLINK CONTROL CHANNEL MONITORING SKIPPING

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/274,288

(22) Filed: Jul. 18, 2025

Related U.S. Application Data
(60) Provisional application No. 63/683,182, filed on Aug. 14, 2024.

(51) Int. Cl. H04W 72/25; H04W 28/02; H04W 72/1273; H04W 76/28

(52) U.S. Cl. CPC H04W 72/25; H04W 28/0278; H04W 72/1273; H04W 76/28

(57) ABSTRACT

Methods, systems, and devices for wireless communications are described. The UE may receive an indication to skip physical downlink control channel (PDCCH) monitoring during a first set of slots and enabling a PDCCH skip inactivity timer. The UE may resume PDCCH monitoring during a second set of slots subsequent to the first set of slots in accordance with the PDCCH skip inactivity timer. If the UE receives a scheduling grant during the second set of slots, the UE may resume PDCCH monitoring during the third set of slots. Alternatively, if the UE does not receive the scheduling grant, the UE may resume PDCCH monitoring skipping during the third set of slots. In such examples, a network entity in communications with the UE may transmit fewer additional DCI to indicate for the UE to resume PDCCH skipping, which may save communication resources and reduce network loading.

### CROSS REFERENCE

The present Application for Patent claims the benefit of U.S. Provisional Ser. No. 63/683,182 by YANG et al., entitled “PHYSICAL DOWNLINK CONTROL CHANNEL SKIP INACTIVITY TIMER FOR RESUMING PHYSICAL DOWNLINK CONTROL CHANNEL MONITORING SKIPPING,” filed Aug. 14, 2024, assigned to the assignee hereof, and which is expressly incorporated by reference in its entirety herein.

### FIELD OF TECHNOLOGY

The following relates to wireless communications, including a physical downlink control channel (PDCCH) skip inactivity timer for resuming PDCCH monitoring skipping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an indication of a physical downlink control channel (PDCCH) skip inactivity timer, monitoring, for a first downlink control information (DCI), a second set of one or more slots in accordance with a PDCCH skip indication and a PDCCH skip inactivity timer, the second set of one or more slots being subsequent to a first set of one or more slots and the second set of one or more slots being defined by the PDCCH skip inactivity timer, and resuming PDCCH skipping or discontinuing PDCCH skipping for a third set of one or more slots based on the monitoring and if the first DCI is absent from the second set of one or more slots that excludes the PDCCH skip indication, the third set of one or more slots being subsequent to the second set of one or more slots.

A UE for wireless communications is described. The UE may include one or more memories storing processor executable code, and one or more processors coupled with the one or more memories. The one or more processors may individually or collectively be operable to execute the code to cause the UE to receive an indication of a PDCCH skip inactivity timer, monitor, for a first DCI, a second set of one or more slots in accordance with a PDCCH skip indication and a PDCCH skip inactivity timer, the second set of one or more slots being subsequent to a first set of one or more slots and the second set of one or more slots be defined by the PDCCH skip inactivity timer, and resume PDCCH skipping or discontinuing PDCCH skipping for a third set of one or more slots based on the monitoring and if the first DCI is absent from the second set of one or more slots that excludes the PDCCH skip indication, the third set of one or more slots being subsequent to the second set of one or more slots.

Another UE for wireless communications is described. The UE may include means for receiving an indication of a PDCCH skip inactivity timer, means for monitoring, for a first DCI, a second set of one or more slots in accordance with a PDCCH skip indication and a PDCCH skip inactivity timer, the second set of one or more slots being subsequent to a first set of one or more slots and the second set of one or more slots being defined by the PDCCH skip inactivity timer, and means for resuming PDCCH skipping or discontinuing PDCCH skipping for a third set of one or more slots based on the monitoring and if the first DCI is absent from the second set of one or more slots that excludes the PDCCH skip indication, means for the third set of one or more slots being subsequent to the second set of one or more slots.

A non-transitory computer-readable medium storing code for wireless communications is described. The code may include instructions executable by one or more processors to receive an indication of a PDCCH skip inactivity timer, monitor, for a first DCI, a second set of one or more slots in accordance with a PDCCH skip indication and a PDCCH skip inactivity timer, the second set of one or more slots being subsequent to a first set of one or more slots and the second set of one or more slots be defined by the PDCCH skip inactivity timer, and resume PDCCH skipping or discontinuing PDCCH skipping for a third set of one or more slots based on the monitoring and if the first DCI is absent from the second set of one or more slots that excludes the PDCCH skip indication, the third set of one or more slots being subsequent to the second set of one or more slots.

Some examples of the method, UEs, and non-transitory computer-readable medium described herein may further include operations, features, means, or instructions for monitoring a PDCCH on the third set of one or more slots for another DCI based on receiving the first DCI during the second set of one or more slots in accordance with the PDCCH skip inactivity timer, the first DCI including a scheduling grant and an indication for the UE to perform PDCCH skipping.

Some examples of the method, UEs, and non-transitory computer-readable medium described herein may further include operations, features, means, or instructions for transmitting capability information indicating one or more of: an indication that the UE supports the PDCCH skip inactivity timer, a preferred quantity of slots for the PDCCH skip inactivity timer, a preference for operating a C-DRX inactivity timer associated with a connected-mode discontinuous reception (C-DRX) active state during the second set of one or more slots defined by the PDCCH skip inactivity timer, or any combination thereof.

Some examples of the method, UEs, and non-transitory computer-readable medium described herein may further include operations, features, means, or instructions for transmitting an indication of one or more preferred parameters associated with the PDCCH skip inactivity timer based on receiving the indication of the PDCCH skip inactivity timer, the one or more preferred parameters including a preferred quantity of slots for the PDCCH skip inactivity timer, a preferred threshold quantity of slots that the UE may perform PDCCH skipping for during a C-DRX active state, a preference for operating a C-DRX inactivity timer associated with the C-DRX active state during the second set of one or more slots, or any combination thereof.

In some examples of the method, UEs, and non-transitory computer-readable medium described herein, and the method, apparatuses, and non-transitory computer-readable medium may include further operations, features, means, or instructions for a quantity of slots associated with the PDCCH skip inactivity timer, a threshold quantity of slots that the UE may resume performing PDCCH skipping for during a C-DRX active duration, or both.

Some examples of the method, UEs, and non-transitory computer-readable medium described herein may further include operations, features, means, or instructions for receiving another DCI indicating to perform PDCCH skipping for the first set of one or more slots and indicating to initiate the PDCCH skip inactivity timer in accordance with a PDCCH skipping resume condition.

In some examples of the method, UEs, and non-transitory computer-readable medium described herein, a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

In some examples of the method, UEs, and non-transitory computer-readable medium described herein, and the method, apparatuses, and non-transitory computer-readable medium may include further operations, features, means, or instructions for a downlink buffer status report (BSR) satisfying a first threshold quantity for a first threshold duration, an uplink BSR satisfying a second threshold quantity for a second threshold duration, or both.

A method for wireless communications by a network entity is described. The method may include transmitting an indication of a PDCCH skip inactivity timer and transmitting a first DCI indicating that a UE is to perform PDCCH skipping for a first set of one or more slots and to monitor, for another DCI, a second set of one or more slots in accordance with the PDCCH skip inactivity timer, where an absence of the other DCI in the second set of one or more slots indicates a resumption of PDCCH skipping for a third set of one or more slots, the second set of one or more slots being subsequent to the first set of one or more slots and the third set of one or more slots being subsequent to the second set of one or more slots.

A network entity for wireless communications is described. The network entity may include one or more memories storing processor executable code, and one or more processors coupled with the one or more memories. The one or more processors may individually or collectively be operable to execute the code to cause the network entity to transmit an indication of a PDCCH skip inactivity timer and transmit a first DCI indicating that a UE is to perform PDCCH skipping for a first set of one or more slots and to monitor, for another DCI, a second set of one or more slots in accordance with the PDCCH skip inactivity timer, where an absence of the other DCI in the second set of one or more slots indicates a resumption of PDCCH skipping for a third set of one or more slots, the second set of one or more slots being subsequent to the first set of one or more slots and the third set of one or more slots being subsequent to the second set of one or more slots.

Another network entity for wireless communications is described. The network entity may include means for transmitting an indication of a PDCCH skip inactivity timer and means for transmitting a first DCI indicating that a UE is to perform PDCCH skipping for a first set of one or more slots and to monitor, for another DCI, a second set of one or more slots in accordance with the PDCCH skip inactivity timer, where an absence of the other DCI in the second set of one or more slots indicates a resumption of PDCCH skipping for a third set of one or more slots, the second set of one or more slots being subsequent to the first set of one or more slots and the third set of one or more slots being subsequent to the second set of one or more slots.

A non-transitory computer-readable medium storing code for wireless communications is described. The code may include instructions executable by one or more processors to transmit an indication of a PDCCH skip inactivity timer and transmit a first DCI indicating that a UE is to perform PDCCH skipping for a first set of one or more slots and to monitor, for another DCI, a second set of one or more slots in accordance with the PDCCH skip inactivity timer, where an absence of the other DCI in the second set of one or more slots indicates a resumption of PDCCH skipping for a third set of one or more slots, the second set of one or more slots being subsequent to the first set of one or more slots and the third set of one or more slots being subsequent to the second set of one or more slots.

In some examples of the method, network entities, and non-transitory computer-readable medium described herein, and the method, apparatuses, and non-transitory computer-readable medium may include further operations, features, means, or instructions for a downlink BSR satisfying a first threshold quantity for a first threshold duration, an uplink BSR satisfying a second threshold quantity for a second threshold duration, or both.

In some examples of the method, network entities, and non-transitory computer-readable medium described herein, a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

Some examples of the method, network entities, and non-transitory computer-readable medium described herein may further include operations, features, means, or instructions for receiving capability information indicating one or more of: an indication that the UE supports the PDCCH skip inactivity timer, a preferred quantity of slots for the PDCCH skip inactivity timer, a preference for operating a C-DRX inactivity timer associated with a C-DRX active state during the second set of one or more slots defined by the PDCCH skip inactivity timer, or any combination thereof and determining a configuration for the PDCCH skip inactivity timer based on the capability information.

Some examples of the method, network entities, and non-transitory computer-readable medium described herein may further include operations, features, means, or instructions for receiving an indication of one or more preferred parameters associated with the UE for the PDCCH skip inactivity timer, the one or more preferred parameters including a preferred quantity of slots for the PDCCH skip inactivity timer, a preferred threshold quantity of slots that the UE may perform PDCCH skipping for during a C-DRX active state, a preference for operating a C-DRX inactivity timer associated with the C-DRX active state during the second set of one or more slots, or any combination thereof and determining a configuration for the PDCCH skip inactivity timer based on the one or more preferred parameters.

In some examples of the method, UEs, and non-transitory computer-readable medium described herein, a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

In some examples of the method, apparatus, and non-transitory computer-readable medium described herein, a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

Details of one or more aspects of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports a physical downlink control channel (PDCCH) skip inactivity timer for resuming PDCCH monitoring skipping in accordance with one or more aspects of the present disclosure.

FIG. 2 shows an example of a wireless communications system that supports a PDCCH skip inactivity timer for resuming PDCCH monitoring skipping in accordance with one or more aspects of the present disclosure.

FIG. 3 shows an example of a process flow that supports a PDCCH skip inactivity timer for resuming PDCCH monitoring skipping in accordance with one or more aspects of the present disclosure.

FIGS. 4 and 5 show block diagrams of devices that support PDCCH skip inactivity timer for resuming PDCCH monitoring skipping in accordance with one or more aspects of the present disclosure.

FIG. 6 shows a block diagram of a communications manager that supports a PDCCH skip inactivity timer for resuming PDCCH monitoring skipping in accordance with one or more aspects of the present disclosure.

FIG. 7 shows a diagram of a system including a device that supports a PDCCH skip inactivity timer for resuming PDCCH monitoring skipping in accordance with one or more aspects of the present disclosure.

FIGS. 8 and 9 show block diagrams of devices that support PDCCH skip inactivity timer for resuming PDCCH monitoring skipping in accordance with one or more aspects of the present disclosure.

FIG. 10 shows a block diagram of a communications manager that supports a PDCCH skip inactivity timer for resuming PDCCH monitoring skipping in accordance with one or more aspects of the present disclosure.

FIG. 11 shows a diagram of a system including a device that supports a PDCCH skip inactivity timer for resuming PDCCH monitoring skipping in accordance with one or more aspects of the present disclosure.

FIGS. 12 and 13 show flowcharts illustrating methods that support PDCCH skip inactivity timer for resuming PDCCH monitoring skipping in accordance with one or more aspects of the present disclosure.

### DETAILED DESCRIPTION

In some wireless communications systems, devices may perform operations to save device power. In some examples, a user equipment (UE) may skip monitoring for downlink signaling (e.g., a physical downlink control channel (PDCCH)) for a duration (e.g., a defined number of slots or another defined time period) if the UE is not expected to receive signaling during the duration. The UE may receive an indication that the UE is to perform PDCCH skipping from a network entity. In some cases, the UE may receive additional signaling from the network entity indicating that the UE is to resume PDCCH skipping. For example, the UE may receive downlink control information (DCI) that does not include a scheduling grant (e.g., a dummy DCI) to indicate for the UE to resume PDCCH skipping (e.g., resume skipping monitoring). In some cases, the UE may operate in accordance with a connected-mode discontinuous reception (C-DRX) cycle, and the UE may receive multiple dummy DCIs to continue perform PDCCH skipping until a C-DRX inactivity timer expires (e.g., until the UE enters an inactive mode). However, each dummy DCI may occupy communication resources, which may impact network loading.

Various aspects of the present disclosure are related to a PDCCH skip inactivity timer for resuming PDCCH monitoring skipping. In some examples, a UE may receive signaling indicating a configuration for a PDCCH skip inactivity timer. The configuration may indicate a quantity of slots associated with the PDCCH skip inactivity timer. The UE may monitor for signaling during an active duration of a C-DRX cycle. In some examples, the UE may receive DCI indicating to skip monitoring for PDCCH during a first set of slots and may skip monitoring during the first set of slots. The UE may monitor for PDCCH (e.g., resume PDCCH monitoring) during a second set of slots after the first set of slots in accordance with the PDCCH skip inactivity timer. If the UE does not receive a grant during the second set of slots (e.g., before the PDCCH skip inactivity timer expires), the UE may resume PDCCH monitoring skipping. For example, the UE may skip monitoring for PDCCH during a third set of slots after the second set of slots without receiving, during the second set of slots, an indication to skip monitoring for the PDCCH during the third set of slots. If the UE receives a grant during the second set of slots, the UE may monitor for PDCCH. The UE may monitor for PDCCH until the UE receives another command to skip PDCCH monitoring (e.g., a second DCI) or until a C-DRX inactivity timer expires and the UE enters a sleep mode. Additionally, or alternatively, the UE may enter the sleep mode after the UE skips a threshold quantity of slots within a C-DRX cycle.

Aspects of the disclosure are initially described in the context of wireless communications systems. Aspects of the disclosure are additionally illustrated with reference to process flows. Aspects of the disclosure are further illustrated by and described with reference to apparatus diagrams, system diagrams, and flowcharts that relate to PDCCH skip inactivity timer for resuming PDCCH monitoring skipping.

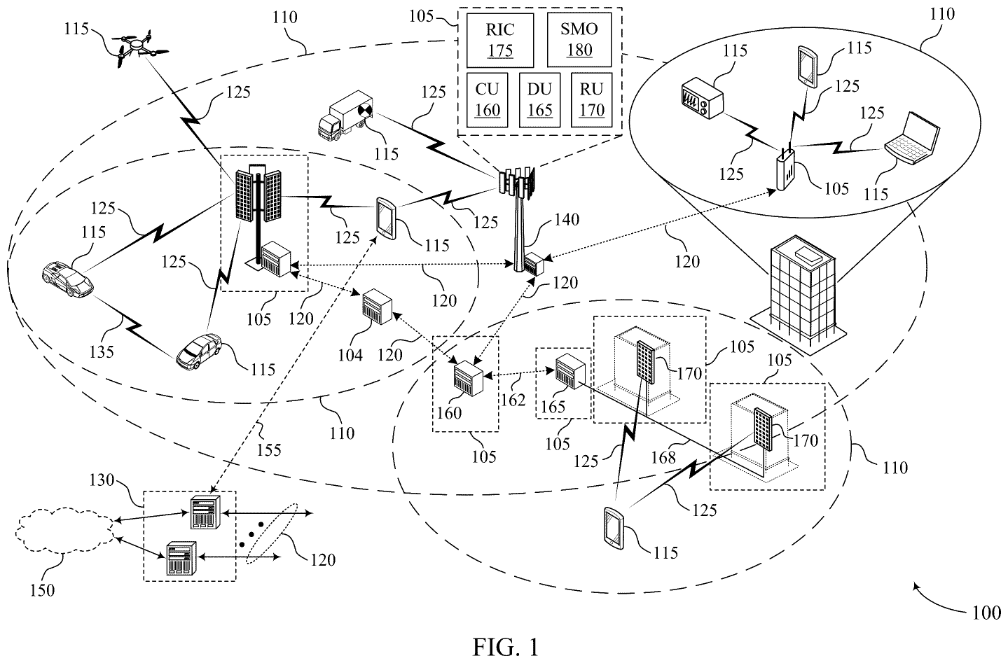

FIG. 1 shows an example of a wireless communications system 100 that supports a PDCCH skip inactivity timer for resuming PDCCH monitoring skipping in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, a UE 115 may receive signaling indicating a configuration for a PDCCH skip inactivity timer from a network entity 105. The UE 115 may be configured with a C-DRX cycle and may monitor for signaling during an active duration of the C-DRX cycle. In some examples, the UE 115 may receive a first DCI indicating to skip monitoring for PDCCH during a first set of slots and may skip monitoring during the first set of slots. The UE 115 may resume monitoring for PDCCH during a second set of slots subsequent to the first set of slots in accordance with the PDCCH skip inactivity timer. For example, the PDCCH skip inactivity timer may define the second set of slots. If the UE 115 does not receive a scheduling grant during the second set of slots (e.g., before the PDCCH skip inactivity timer expires), the UE 115 may resume PDCCH skipping. For example, the UE 115 may skip monitoring for PDCCH during a third set of slots subsequent to the second set of slots if the UE 115 does not receive another DCI (e.g., a second DCI) including a scheduling grant during the second set of slots. In such examples, the UE 115 may skip monitoring for the PDCCH during the third set of slots without receiving, during the second set of slots an indication to skip monitoring for the PDCCH during the third set of slots. If the UE 115 receives a grant during the second set of slots, the UE 115 may monitor for PDCCH during the remainder of the C-DRX active duration (e.g., a C-DRX active state). In some examples, the UE 115 may monitor for PDCCH until the UE 115 receives a command (e.g., a second indication) to skip PDCCH monitoring (e.g., another DCI) or until a C-DRX inactivity timer expires and the UE 115 enters a sleep mode. Additionally, or alternatively, the UE 115 may enter the sleep mode after skipping a threshold quantity of slots within the C-DRX cycle.

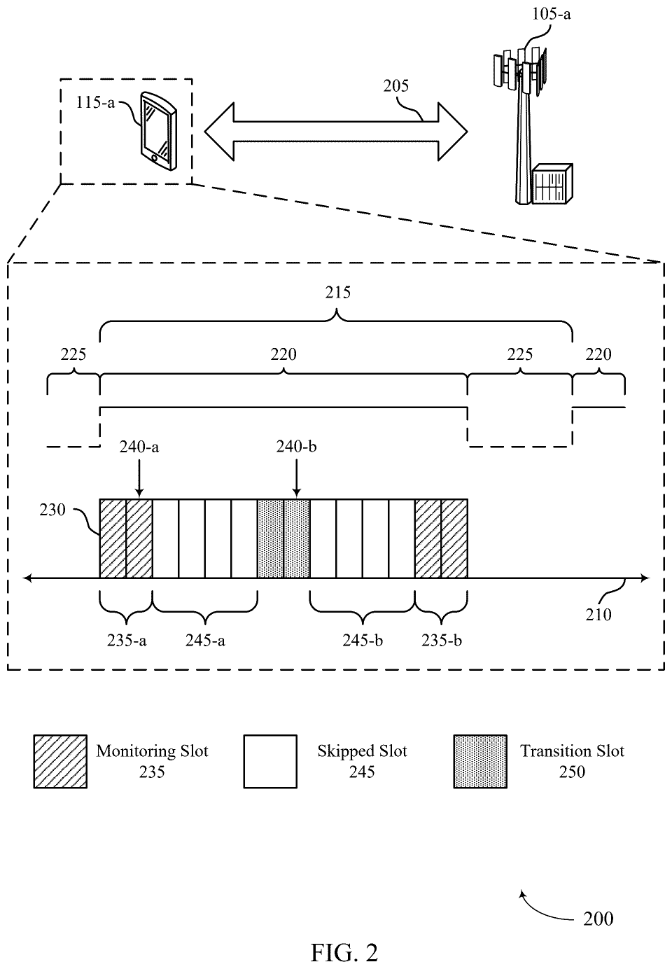

FIG. 2 shows an example of a wireless communications system 200 that supports a PDCCH skip inactivity timer for resuming PDCCH monitoring skipping in accordance with one or more aspects of the present disclosure. The wireless communications system 200 may include a UE 115-a in communications with a network entity 105-a, which may be examples of corresponding devices describes herein, including with reference to FIG. 1. The UE 115-a may communicate with the network entity 105-a via a communication link 205, which may be an example of an uplink, a downlink, or both. For example, communications between the UE 115-a and the network entity 105-a via the communication link 205 may include uplink communications, downlink communications, or both.

The UE 115-a and the network entity 105-a may communicate signaling in accordance with the timeline 210. In some examples, devices in the wireless communications system 200 may cycle between an active mode and an inactive mode to save device power. For example, the UE 115-a may be configured for discontinuous reception (DRX). In some cases, the UE 115-a may establish a connection with the network entity 105-a (e.g., via RRC signaling) and may enter a connected mode (e.g., an RRC connected mode). In such cases, the UE 115-a may be configured for C-DRX. In the example of FIG. 2, the UE 115-a may establish a connection with the network entity 105-a and may operate in accordance with a C-DRX cycle 215. The C-DRX cycle 215 may include an active duration 220 and an inactive duration 225. In the example of FIG. 2, a single C-DRX cycle 215 is shown to occur during the timeline 210. However, it should be noted that in some other examples not shown, the C-DRX cycle 215 may repeat over the course of the timeline 210. That is, as shown in the example of FIG. 2, the timeline 210 may include multiple active durations 220 and inactive durations 225. Each active duration 220 and inactive duration 225 may span (e.g., include) a quantity of slots 230.

The UE 115-a and the network entity 105-a may refrain from communicating signaling during the inactive duration 225 (e.g., the inactive durations 225). For example, the UE 115-a may not monitor for signaling during the inactive duration 225, which may save power at the UE 115-a. Conversely, the UE 115-a and the network entity 105-a may communicate signaling during the active duration 220 (e.g., the active durations 220). For example, the network entity may transmit data to the UE 115-a via one or more PDCCHs. The UE 115-a may monitor for the one or more PDCCHs during one or more monitoring slots 235 (e.g., a first subset of monitoring slots 235-a). The one or more monitoring slots 235 may occur within the active duration 220 (e.g., one or more slots 230 of the active duration 220) of the C-DRX cycle 215. In some examples, the UE 115-a may transition between the active duration 220 (e.g., an active mode) and the inactive duration 225 (e.g., an inactive mode) in accordance with a timer (e.g., a C-DRX inactivity timer). The C-DRX inactivity timer may span (e.g., include) the active duration 220 of the C-DRX cycle 215. When the C-DRX inactivity timer expires, the UE 115-a may transition from the active duration 220 to the inactive duration 225.

In some examples, if the network entity 105-a determines that there is no data to be transmitted to the UE 115-a for an upcoming duration (e.g., an upcoming quantity of slots), the network entity 105-a may indicate for the UE 115-a to skip monitoring for PDCCH. For example, the network entity 105-a may transmit DCI 240 (e.g., first DCI 240-a) to the UE 115-a indicating for the UE 115-a to refrain from monitoring one or more skipped slots 245 (e.g., a first set of slots 230). The UE 115-a may receive the first DCI 240-a during the first subset of monitoring slots 235-a and may skip monitoring for PDCCH (e.g., may skip PDCCH) during a first subset of skipped slots 245-a in accordance with the first DCI 240-a.

In some aspects, the UE 115-a may resume monitoring for PDCCH after the first subset of skipped slots 245-a (e.g., in slots 230 subsequent to the first subset of skipped slots 245-a). The network entity 105-a may transmit a grantless DCI 240 (e.g., a dummy DCI 240) to the UE 115-a indicating for the UE 115-a to resume PDCCH skipping (e.g., PDCCH monitoring skipping) for another one or more skipped slots 245. In some cases, if the network entity 105-a determines that there is no data to be transmitted to the UE 115-a for the remainder of the active duration 220 of the C-DRX cycle 215, the network entity 105-a may transmit multiple dummy DCI 240 to the UE 115-a within the active duration 220 such that the UE 115-a continues to skip PDCCH monitoring for the remainder of the active duration 220. However, each dummy DCI 240 may consume overhead and impact PDCCH loading for the wireless communications system 200 (e.g., communications between the UE 115-a and the network entity 105-a). Accordingly, it may be beneficial for the UE 115-a to resume PDCCH monitoring skipping without receiving additional dummy DCI 240 from the network entity 105-a.

Techniques described herein provide for resuming PDCCH skipping in accordance with a PDCCH skip inactivity timer. In some examples, the network entity 105-a may transmit an indication of the PDCCH skip inactivity timer to the UE 115-a. For example, the network entity 105-a may configure the UE 115-a with the PDCCH skip inactivity timer. The PDCCH skip inactivity timer may indicate (e.g., define) a quantity of slots 230 for the UE 115-a to stop PDCCH skipping and to monitor for PDCCH. For example, the PDCCH skip inactivity timer may indicate one or more transition slots 250 (e.g., a second set of slots 230) subsequent to the first subset of skipped slots 245-a during which the UE 115-a may monitor for PDCCH before resuming PDCCH skipping. The UE 115-a may perform PDCCH skipping during the first subset of skipped slots 245-a, and the UE 115-a may monitor for PDCCH during the transition slots 250. The UE 115-a may determine whether to continue performing PDCCH skipping or whether to begin monitoring for PDCCH based on signaling (e.g., an absence of signaling) received during the transition slots 250.

The UE 115-a may transmit a capability message to the network entity 105-a. In some examples, the capability message may indicate whether the UE 115-a supports the PDCCH skip inactivity timer. In response to receiving the capability message, the network entity 105-a may configure the PDCCH skip inactivity timer based on the capability of the UE 115-a indicated in the capability message and may enable the PDCCH skip inactivity timer at the UE 115-a. For example, the network entity 105-a may transmit signaling indicating (e.g., enabling) a configuration for the PDCCH skip inactivity timer at the UE 115-a. In some examples, the network entity 105-a may indicate the PDCCH skip inactivity timer to the UE 115-a via RRC signaling. For example, the network entity 105-a may transmit an RRC connection reconfiguration message including an indication of the PDCCH skip inactivity timer.

In some examples, the network entity 105-a may configure one or more additional parameters associated with the PDCCH skip inactivity timer. For example, the network entity 105-a may indicate a threshold quantity (e.g., a maximum quantity) of slots 230 during which the UE 115-a may skip PDCCH monitoring. Additionally, or alternatively, the network entity 105-a may indicate instructions for handling (e.g., operating) the C-DRX inactivity timer at the UE 115-a. For example, the network entity 105-a may indicate for the UE 115-a to pause the C-DRX inactivity timer or to continue running the C-DRX inactivity timer during the first subset of skipped slots 245-a, during the transition slots 250, or any combination thereof. Additionally, or alternatively, the network entity 105-a may indicate for the UE 115-a to reset the C-DRX inactivity timer during the first subset of skipped slots 245-a, during the transition slots 250, or both. In an example, the network entity 105-a may indicate for the UE 115-a to reset the C-DRX inactivity timer during the first subset of skipped slots 245-a and may indicate for the UE 115-a to pause the C-DRX inactivity timer during the transition slots 250.

In some examples, after receiving the RRC signaling from the network entity including the indication of the PDCCH skip inactivity timer, the UE 115-a may transmit an indication of one or more preferred parameters for the PDCCH skip inactivity timer to the network entity 105-a. For example, the network entity 105-a may determine multiple configurations for the PDCCH skip inactivity timer and may indicate the multiple configurations to the UE 115-a. The one or more preferred parameters may include a preferred duration (e.g., a preferred quantity of slots 230) for the PDCCH skip inactivity timer, a preferred threshold quantity of slots during which the UE 115-a may skip PDCCH monitoring, a preference for handling the C-DRX inactivity timer at the UE 115-a, or any combination thereof. The UE 115-a may determine one or more preferred parameters from the multiple configurations and may indicate the preferred parameters to the network entity 105-a. In some cases, the UE 115-a may transmit control signaling (e.g., RRC signaling, a medium access control-control element (MAC-CE)) indicating the preferred parameters to the network entity 105-a. Responsive to receiving the indication of the preferred parameters from the UE 115-a, the network entity 105-a may determine a configuration for the PDCCH skip inactivity timer. For example, the network entity 105-a may reconfigure the PDCCH skip inactivity timer in accordance with the preferred parameters. Alternatively, the network entity 105-a may not determine the configuration based on the one or more preferred parameters.

The network entity 105-a may transmit the first DCI 240-a to indicate to the UE 115-a to initiate PDCCH skipping. For example, the first DCI 240-a may include an indication to perform PDCCH skipping during the first subset of skipped slots 245-a. In some examples, the network entity 105-a may also indicate the parameters for the PDCCH skip inactivity timer in the first DCI 240-a. For example, in addition to the indication to perform PDCCH skipping, the first DCI 240-a may include an indication to initiate (e.g., activate) the PDCCH skip inactivity timer. Such an indication may include a duration for the PDCCH skip inactivity timer. Additionally, or alternatively, the first DCI 240-a may include instructions for handling the C-DRX inactivity timer at the UE 115-a. In such examples, the network entity may transmit the first DCI 240-a in response to receiving the indication of the preferred parameters from the UE 115-a. For example, the duration of the PDCCH skip inactivity timer indicated in the first DCI 240-a may be the same as the preferred duration for the PDCCH skip inactivity timer indicated by the UE 115-a.

In some examples, the network entity 105-a may transmit the first DCI 240-a in response to one or more PDCCH skip conditions satisfying a threshold. For example, the network entity 105-a may monitor network conditions for the wireless communications system 200. If the network entity 105-a detects that a PDCCH skip condition satisfies (e.g., meets, is equal to) a threshold for a duration (e.g., a predefined time), the network entity 105-a may transmit the first DCI 240-a indicating to perform PDCCH skipping. The PDCCH skip conditions may include a downlink buffer status report (BSR) indicating a value of zero (0), an uplink BSR indicating a value of zero (0), or both.

The UE 115-a may monitor for PDCCH during the first subset of monitoring slots 235-a of the active duration 220. If the UE 115-a receives the first DCI 240-a during the first subset of monitoring slots 235-a, the UE 115-a may perform PDCCH skipping in accordance with the indication included in the first DCI 240-a. For example, the UE 115-a may skip PDCCH monitoring during the first subset of skipped slots 245-a in accordance with the indicated PDCCH skip inactivity timer duration. Similarly, the UE 115-a may pause, reset, or continue running the C-DRX inactivity timer during the first subset of skipped slots 245-a in accordance with the indicated instructions for handling the C-DRX inactivity timer. After skipping PDCCH during the first subset of skipped slots 245-a, the UE 115-a may monitor for PDCCH during the transition slots 250 in accordance with the first DCI 240-a. For example, the duration for the PDCCH skip inactivity timer indicated by the first DCI 240-a may define a quantity of transition slots 250 for the UE 115-a to monitor for PDCCH. If the UE 115-a does not receive a PDCCH (e.g., a PDCCH including a scheduling grant) during the transition slots 250, the UE 115-a may resume PDCCH skipping.

In some examples, the UE 115-a may resume PDCCH skipping for a second subset of skipped slots 245-b (e.g., a third set of slots 230) subsequent to the transition slots 250. In some cases, a length (e.g., duration) of the second subset of skipped slots 245-b may be the same as the first subset of skipped slots 245-a. For example, the second subset of skipped slots 245-b may span (e.g., include) a same quantity of skipped slots 245 as the first subset of skipped slots 245-a. In some other cases, the length of the second subset of skipped slots 245-b may be different than the first subset of skipped slots 245-a. For example, the second subset of skipped slots 245-b may span a greater quantity of skipped slots 245 than the first subset of skipped slots 245-a (e.g., the second subset of skipped slots 245-b may be longer than the first subset of skipped slots 245-a). Alternatively, the second subset of skipped slots 245-b may span a smaller quantity of skipped slots 245 than the first subset of skipped slots 245-a (e.g., the second subset of skipped slots 245-b may be shorter than the first subset of skipped slots 245-a). In such examples, the UE 115-a may resume PDCCH skipping during the second subset of skipped slots 245-b without receiving an indication to resume the PDCCH skipping (e.g., an indication to skip monitoring for PDCCH during the second subset of skipped slots 245-b) during the transition slots 250. The UE 115-a may resume monitoring for PDCCH for a remainder of the active duration 220 after the skipping PDCCH monitoring during the second subset of skipped slots 245-b. For example, the UE 115-a may resume monitoring for PDCCH during a second subset of monitoring slots 235-b.

Alternatively, if the UE 115-a receives a scheduling grant (e.g., a PDCCH including a scheduling grant) during the transition slots 250, the UE 115-a may discontinue (e.g., refrain from, stop) PDCCH skipping and may resume monitoring for PDCCH during the active duration 220 of the C-DRX cycle 215. For example, the UE 115-a may receive a second DCI 240-b during the transition slots 250 that includes a scheduling grant. In some cases, the UE 115-a may continue monitoring for PDCCH within the active duration 220 until the UE 115-a receives another command (e.g., indication) to perform PDCCH skipping. Additionally, or alternatively, the UE 115-a may continue monitoring for PDCCH within the active duration 220 until the UE 115-a skips a threshold quantity of PDCCH, after which the UE 115-a may transition into a C-DRX sleep mode to further save power at the UE 115-a. For example, the UE 115-a may continue monitoring for PDCCH within the active duration 220 until a quantity of slots during which the UE 115-a skips PDCCH monitoring satisfies (e.g., is greater than or equal to) the threshold quantity of slots during which the UE may skip PDCCH monitoring. In some other cases, the UE 115-a may continue monitoring for PDCCH within the active duration 220 until expiration of the C-DRX inactive timer. If the C-DRX inactive timer expires, the UE 115-a may transition into the C-DRX sleep mode to further save power at the UE 115-a.

The techniques described herein may enable reduced communication overhead for the wireless communications system 200 and improved power savings for the UE 115-a. For example, implementing the PDCCH skip inactivity timer may enable the network entity 105-a to reduce a quantity of signals transmitted via PDCCH, which may reduce network loading and the demand for DCIs 240 within the wireless communications system 200. Similarly, implementing the PDCCH skip inactivity timer at the UE 115-a may enable the UE 115-a to selectively determine whether to continue monitoring for PDCCH or whether to skip PDCCH monitoring in accordance with signals received by the UE 115-a. In such cases, the UE 115-a may monitor for PDCCH less frequently relative to configurations that do not enable the PDCCH skip inactivity timer, which may reduce power consumption at the UE 115-a.

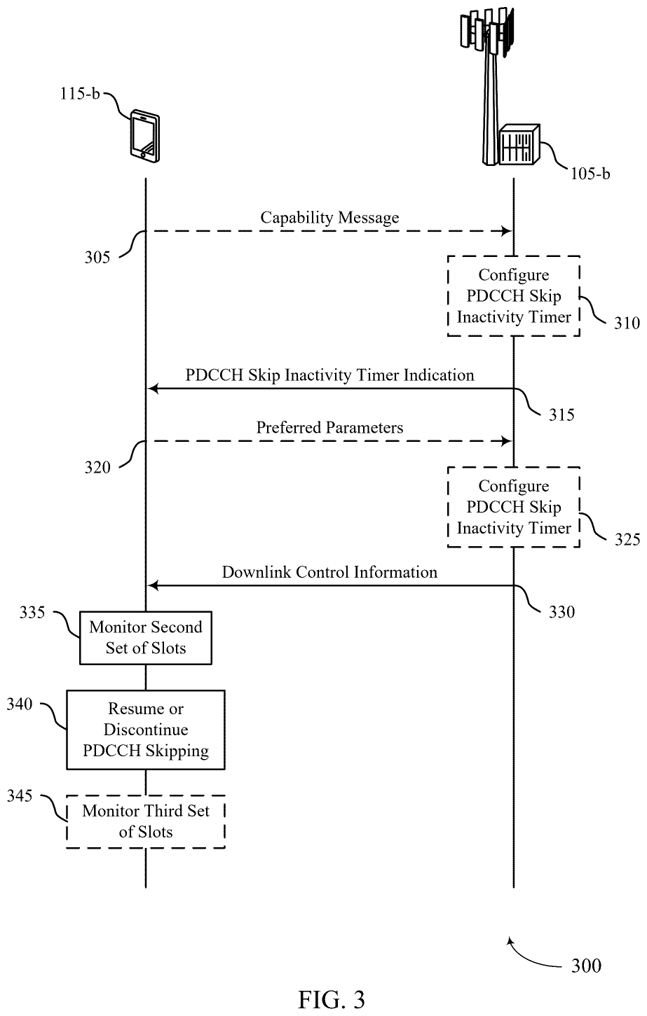

FIG. 3 shows an example of a process flow 300 that supports a PDCCH skip inactivity timer for resuming PDCCH monitoring skipping in accordance with one or more aspects of the present disclosure. The process flow 300 may implement or be implemented by aspects of the wireless communications system 100 and the wireless communications system 200, as described with reference to FIGS. 1 and 2. For example, the process flow 300 may illustrate actions performed by a UE 115-b and a network entity 105-b. In the following description of the process flow 300, the operations between the UE 115-b and the network entity 105-b may be performed in a different order than the example shown, or the operations between the UE 115-b and the network entity 105-b may be performed in different orders at different times. Some operations may also be omitted from the process flow 300, and other operations may be added to the process flow 300.

At 305, the UE 115-b may transmit capability information indicating one or more of: an indication that the UE supports the PDCCH skip inactivity timer, a preferred quantity of slots for the PDCCH skip inactivity timer, a preference for operating a C-DRX inactivity timer associated with a C-DRX active state during the second set of one or more slots defined by the PDCCH skip inactivity timer, or any combination thereof. The network entity 105-b may receive the capability information indicating that the UE 115-b supports the PDCCH skip inactivity timer, and responsive to receiving the capability information, at 310, the network entity 105-b may determine a configuration for the PDCCH skip inactivity timer based on the capability information. In some examples, the configuration may include multiple parameters.

At 315, the UE 115-b may receive an indication of the PDCCH skip inactivity timer from the network entity 105-b. The indication of the PDCCH skip inactivity timer may include one or more of: a quantity of slots associated with the PDCCH skip inactivity timer, a threshold quantity of slots that the UE 115-b may perform PDCCH skipping for during a C-DRX active state, or both. In some examples, the indication may include multiple quantities of slots associated with the PDCCH skip inactivity timer, multiple threshold quantities of slots that the UE 115-b may perform PDCCH skipping for during a C-DRX active state, or both.

At 320, the UE 115-b may transmit an indication of one or more preferred parameters associated with the PDCCH skip inactivity timer based on receiving the indication of the PDCCH skip inactivity timer. The one or more preferred parameters may include a preferred quantity of slots for the PDCCH skip inactivity timer, a preferred threshold quantity of slots that the UE may perform PDCCH skipping for during a C-DRX active state, a preference for operating a C-DRX inactivity timer associated with the C-DRX active state during a second set of one or more slots, or any combination thereof. In some examples, the UE 115-b may receive an indication of multiple parameters for the PDCCH skip inactivity timer and may determine the one or more preferred parameters based on the indication of the multiple parameters.

The network entity 105-b may receive the indication of the one or more preferred parameters from the UE 115-b. Responsive to receiving the indication of the one or more preferred parameters, at 325, the network entity 105-b may determine the configuration for the PDCCH skip inactivity timer based on the one or more preferred parameters. In some examples, the network entity 105-b may determine a reconfiguration for the PDCCH skip inactivity timer based on the one or more preferred parameters. Alternatively, the network entity 105-b may not determine the configuration based on the one or more preferred parameters.

At 330, the network entity 105-b may transmit a first DCI indicating that the UE 115-b is to perform PDCCH skipping for a first set of one or more slots and to monitor, for another DCI (e.g., a second DCI), the second set of one or more slots in accordance with the PDCCH skip inactivity timer. In some cases, an absence of the other DCI in the second set of one or more slots may indicate a resumption of PDCCH skipping for a third set of one or more slots. The second set of one or more slots may be subsequent to the first set of one or more slots, and the third set of one or more slots may be subsequent to the second set of one or more slots. In some examples, the second set of one or more slots may be defined by the PDCCH skip inactivity timer. Additionally, or alternatively, the first DCI may indicate to initiate the PDCCH skip inactivity timer based on a detected PDCCH skipping resume condition, where the detected PDCCH skipping resume condition includes one or more of: a downlink BSR satisfying a first threshold quantity for a first threshold duration, an uplink BSR satisfying a second threshold quantity for a second threshold duration, or both.

At 330, the UE 115-b may receive DCI (e.g., the first DCI) indicating to perform PDCCH skipping for a first set of one or more slots and indicating to initiate the PDCCH skip inactivity timer in accordance with the PDCCH skipping resume condition. In some examples, the downlink control information may indicate one or more of: a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

At 335, the UE 115-b may monitor the second set of one or more slots in accordance with the PDCCH skip indication and the PDCCH skip inactivity timer for additional DCI. At 340, the UE 115-b may resume PDCCH skipping or discontinue PDCCH skipping for a third set of one or more slots based on monitoring the second set of one or more slots and if the additional DCI is absent from the second set of one or more slots that excludes the PDCCH skip indication. In some examples, such as when the UE 115-b does not receive the additional DCI during the second set of one or more slots, the UE 115-b may resume PDCCH skipping. In such examples, the UE 115-b may resume PDCCH skipping during the third set of one or more slots without receiving, during the second set of one or more slots, an indication to resume PDCCH skipping during the third set of one or more slots. In some other examples, at 345, the UE 115-b may monitor a PDCCH on the third set of one or more slots for another DCI based on receiving the additional DCI during the second set of one or more slots in accordance with the PDCCH skip inactivity timer. In such cases, the other (e.g., additional) DCI may include a scheduling grant and an indication for the UE to perform PDCCH skipping.

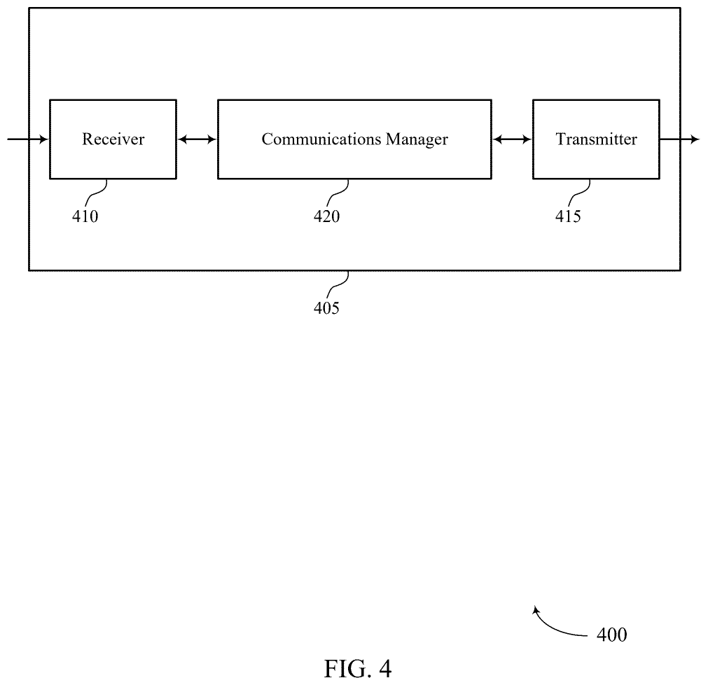

FIG. 4 shows a block diagram 400 of a device 405 that supports a PDCCH skip inactivity timer for resuming PDCCH monitoring skipping in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to a PDCCH skip inactivity timer for resuming PDCCH monitoring skipping). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to a PDCCH skip inactivity timer for resuming PDCCH monitoring skipping). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of a PDCCH skip inactivity timer for resuming PDCCH monitoring skipping as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving an indication of a PDCCH skip inactivity timer. The communications manager 420 is capable of, configured to, or operable to support a means for monitoring, for a first downlink control information, a second set of one or more slots in accordance with a PDCCH skip indication and a PDCCH skip inactivity timer. In some examples, the second set of one or more slots are subsequent to a first set of one or more slots, and the second set of one or more slots are defined by the PDCCH skip inactivity timer. The communications manager 420 is capable of, configured to, or operable to support a means for resuming PDCCH skipping or discontinuing PDCCH skipping for a third set of one or more slots based on the monitoring and if the first downlink control information is absent from the second set of one or more slots that excludes the PDCCH skip indication. In some examples, the third set of one or more slots are subsequent to the second set of one or more slots.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources.

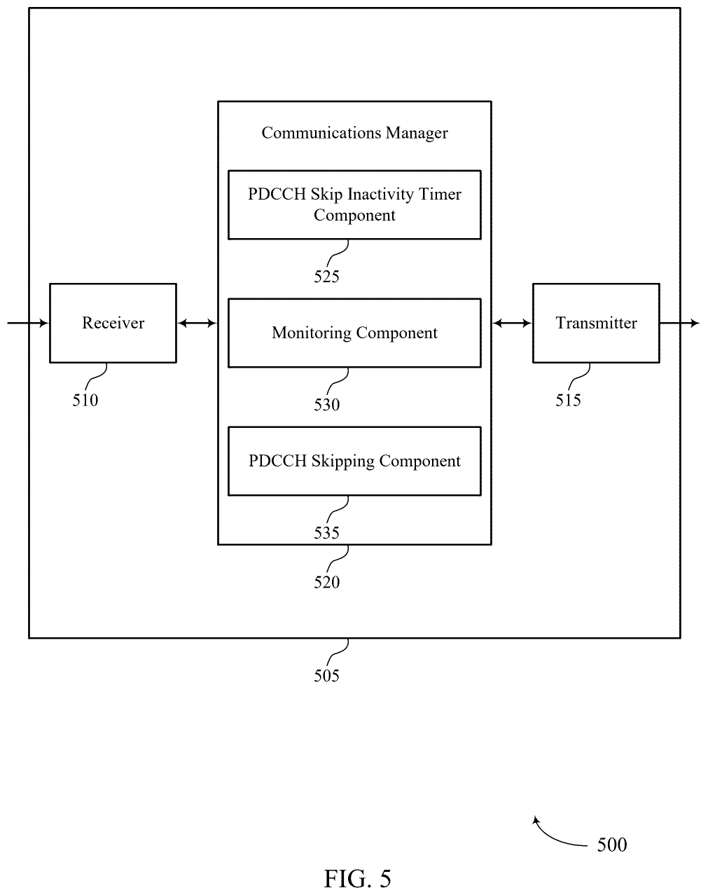

FIG. 5 shows a block diagram 500 of a device 505 that supports a PDCCH skip inactivity timer for resuming PDCCH monitoring skipping in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to a PDCCH skip inactivity timer for resuming PDCCH monitoring skipping). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to a PDCCH skip inactivity timer for resuming PDCCH monitoring skipping). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of a PDCCH skip inactivity timer for resuming PDCCH monitoring skipping as described herein. For example, the communications manager 520 may include a PDCCH skip inactivity timer component 525, a monitoring component 530, a PDCCH skipping component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The PDCCH skip inactivity timer component 525 is capable of, configured to, or operable to support a means for receiving an indication of a PDCCH skip inactivity timer. The monitoring component 530 is capable of, configured to, or operable to support a means for monitoring, for a first downlink control information, a second set of one or more slots in accordance with a PDCCH skip indication and a PDCCH skip inactivity timer. In some examples, the second set of one or more slots are subsequent to a first set of one or more slots, and the second set of one or more slots are defined by the PDCCH skip inactivity timer. The PDCCH skipping component 535 is capable of, configured to, or operable to support a means for resuming PDCCH skipping or discontinuing PDCCH skipping for a third set of one or more slots based on the monitoring and if the first downlink control information is absent from the second set of one or more slots that excludes the PDCCH skip indication. In some examples, the third set of one or more slots are subsequent to the second set of one or more slots.

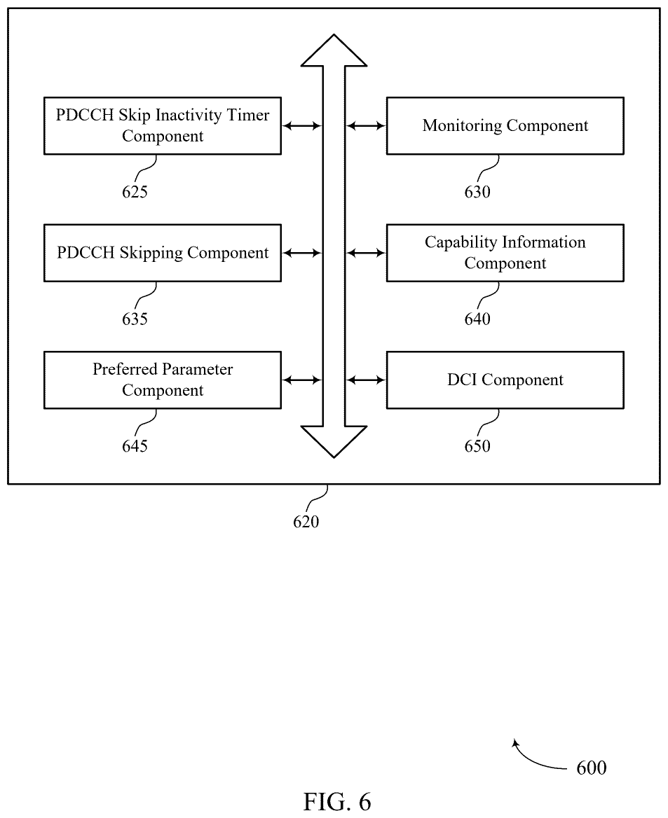

FIG. 6 shows a block diagram 600 of a communications manager 620 that supports a PDCCH skip inactivity timer for resuming PDCCH monitoring skipping in accordance with one or more aspects of the present disclosure. The communications manager 620 may be an example of aspects of a communications manager 420, a communications manager 520, or both, as described herein. The communications manager 620, or various components thereof, may be an example of means for performing various aspects of a PDCCH skip inactivity timer for resuming PDCCH monitoring skipping as described herein. For example, the communications manager 620 may include a PDCCH skip inactivity timer component 625, a monitoring component 630, a PDCCH skipping component 635, a capability information component 640, a preferred parameter component 645, a DCI component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The PDCCH skip inactivity timer component 625 is capable of, configured to, or operable to support a means for receiving an indication of a PDCCH skip inactivity timer. The monitoring component 630 is capable of, configured to, or operable to support a means for monitoring, for a first downlink control information, a second set of one or more slots in accordance with a PDCCH skip indication and a PDCCH skip inactivity timer. In some examples, the second set of one or more slots are subsequent to a first set of one or more slots, and the second set of one or more slots are defined by the PDCCH skip inactivity timer. The PDCCH skipping component 635 is capable of, configured to, or operable to support a means for resuming PDCCH skipping or discontinuing PDCCH skipping for a third set of one or more slots based on the monitoring and if the first downlink control information is absent from the second set of one or more slots that excludes the PDCCH skip indication. In some examples, the third set of one or more slots are subsequent to the second set of one or more slots.

In some examples, the monitoring component 630 is capable of, configured to, or operable to support a means for monitoring a PDCCH on the third set of one or more slots for another downlink control information based on receiving the first downlink control information during the second set of one or more slots in accordance with the PDCCH skip inactivity timer, the first downlink control information including a scheduling grant and an indication for the UE to perform PDCCH skipping.

In some examples, the capability information component 640 is capable of, configured to, or operable to support a means for transmitting capability information indicating one or more of: an indication that the UE supports the PDCCH skip inactivity timer, a preferred quantity of slots for the PDCCH skip inactivity timer, a preference for operating a C-DRX inactivity timer associated with a C-DRX active state during the second set of one or more slots defined by the PDCCH skip inactivity timer, or any combination thereof.

In some examples, the preferred parameter component 645 is capable of, configured to, or operable to support a means for transmitting an indication of one or more preferred parameters associated with the PDCCH skip inactivity timer based on receiving the indication of the PDCCH skip inactivity timer, the one or more preferred parameters including a preferred quantity of slots for the PDCCH skip inactivity timer, a preferred threshold quantity of slots that the UE may perform PDCCH skipping for during a C-DRX active state, a preference for operating a C-DRX inactivity timer associated with the C-DRX active state during the second set of one or more slots, or any combination thereof.

In some examples, the indication of the PDCCH skip inactivity timer includes one or more of: a quantity of slots associated with the PDCCH skip inactivity timer, a threshold quantity of slots that the UE may resume performing PDCCH skipping for during a C-DRX active state, or both.

In some examples, the DCI component 650 is capable of, configured to, or operable to support a means for receiving another downlink control information indicating to perform PDCCH skipping for the first set of one or more slots and indicating to initiate the PDCCH skip inactivity timer in accordance with a PDCCH skipping resume condition.

In some examples, the other downlink control information indicates one or more of: a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

In some examples, the PDCCH skipping resume condition includes one or more of: a downlink buffer status report (BSR) satisfying a first threshold quantity for a first threshold duration, an uplink BSR satisfying a second threshold quantity for a second threshold duration, or both.

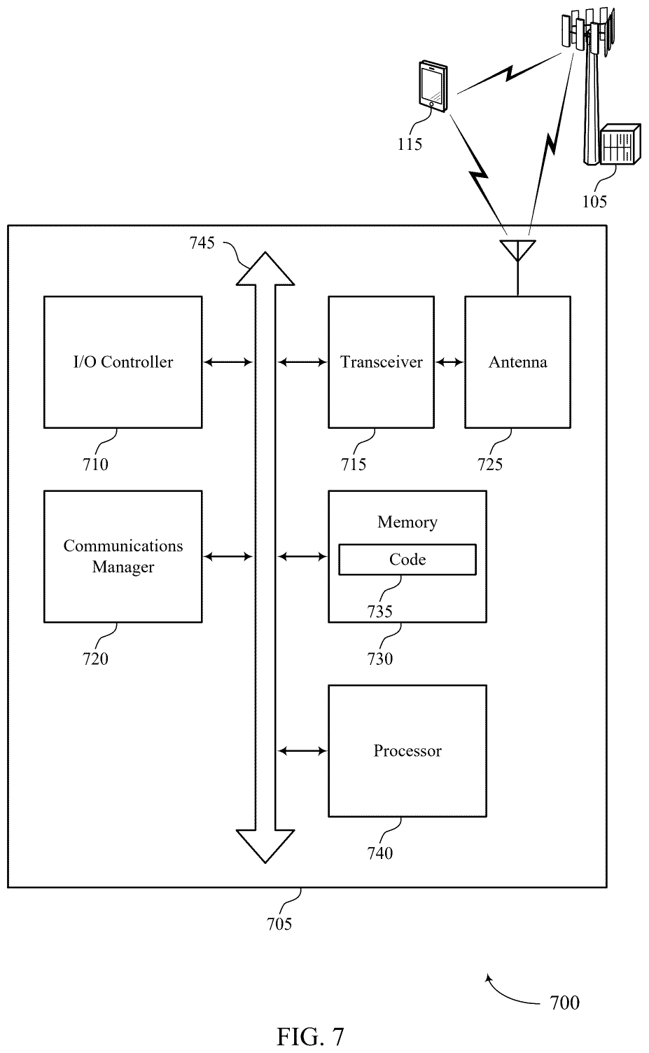

FIG. 7 shows a diagram of a system 700 including a device 705 that supports a PDCCH skip inactivity timer for resuming PDCCH monitoring skipping in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting PDCCH skip inactivity timer for resuming PDCCH monitoring skipping). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving an indication of a PDCCH skip inactivity timer. The communications manager 720 is capable of, configured to, or operable to support a means for monitoring, for a first downlink control information, a second set of one or more slots in accordance with a PDCCH skip indication and a PDCCH skip inactivity timer. In some examples, the second set of one or more slots are subsequent to a first set of one or more slots, and the second set of one or more slots are defined by the PDCCH skip inactivity timer. The communications manager 720 is capable of, configured to, or operable to support a means for resuming PDCCH skipping or discontinuing PDCCH skipping for a third set of one or more slots based on the monitoring and if the first downlink control information is absent from the second set of one or more slots that excludes the PDCCH skip indication. In some examples, the third set of one or more slots are subsequent to the second set of one or more slots.

By including or configuring the communications manager 720 in accordance with examples as described herein, the device 705 may support techniques for reduced latency and improved user experience related to reduced power consumption and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of a PDCCH skip inactivity timer for resuming PDCCH monitoring skipping as described herein, or the at least one processor 740 and the at least one memory 730 may be otherwise configured to, individually or collectively, perform or support such operations.

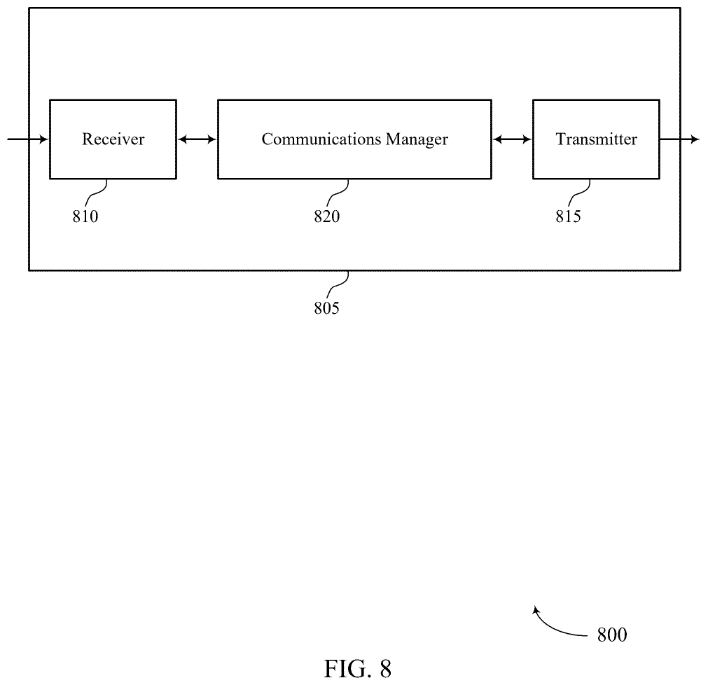

FIG. 8 shows a block diagram 800 of a device 805 that supports a PDCCH skip inactivity timer for resuming PDCCH monitoring skipping in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of a PDCCH skip inactivity timer for resuming PDCCH monitoring skipping as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting an indication of a PDCCH skip inactivity timer. The communications manager 820 is capable of, configured to, or operable to support a means for transmitting a first downlink control information indicating that a UE is to perform PDCCH skipping for a first set of one or more slots and to monitor, for another downlink control information, a second set of one or more slots in accordance with the PDCCH skip inactivity timer, where an absence of the other downlink control information in the second set of one or more slots indicates a resumption of PDCCH skipping for a third set of one or more slots. In some examples, the second set of one or more slots are subsequent to the first set of one or more slots and the third set of one or more slots are subsequent to the second set of one or more slots.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources.

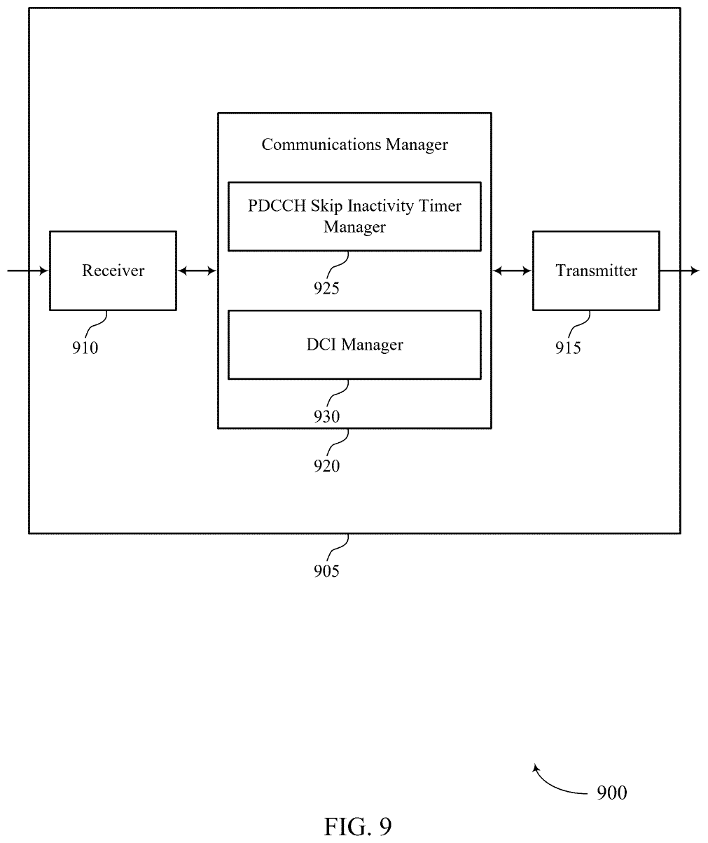

FIG. 9 shows a block diagram 900 of a device 905 that supports a PDCCH skip inactivity timer for resuming PDCCH monitoring skipping in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of a PDCCH skip inactivity timer for resuming PDCCH monitoring skipping as described herein. For example, the communications manager 920 may include a PDCCH skip inactivity timer manager 925 a DCI manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The PDCCH skip inactivity timer manager 925 is capable of, configured to, or operable to support a means for transmitting an indication of a PDCCH skip inactivity timer. The DCI manager 930 is capable of, configured to, or operable to support a means for transmitting a first downlink control information indicating that a UE is to perform PDCCH skipping for a first set of one or more slots and to monitor, for another downlink control information, a second set of one or more slots in accordance with the PDCCH skip inactivity timer, where an absence of the other downlink control information in the second set of one or more slots indicates a resumption of PDCCH skipping for a third set of one or more slots. In some examples, the second set of one or more slots are subsequent to the first set of one or more slots and the third set of one or more slots are subsequent to the second set of one or more slots.

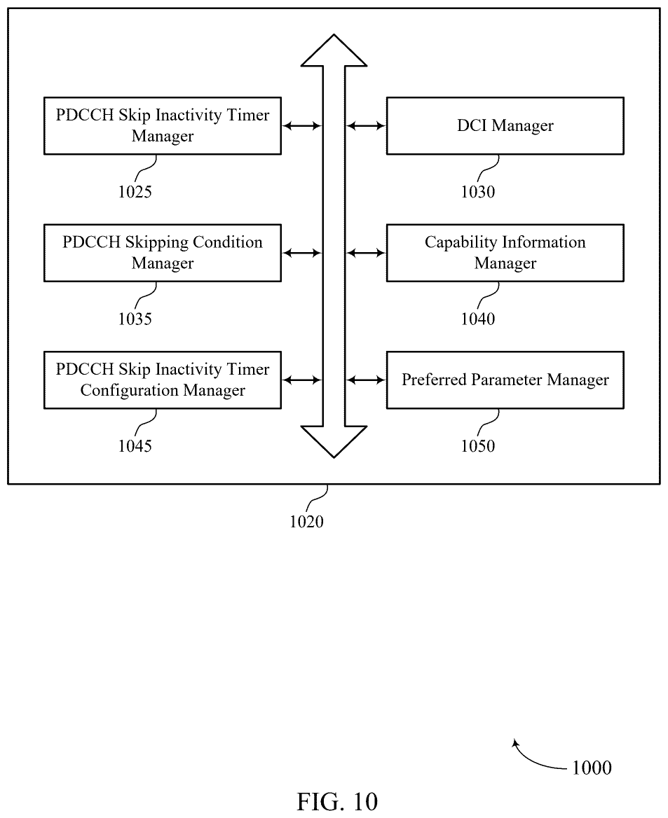

FIG. 10 shows a block diagram 1000 of a communications manager 1020 that supports a PDCCH skip inactivity timer for resuming PDCCH monitoring skipping in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of a PDCCH skip inactivity timer for resuming PDCCH monitoring skipping as described herein. For example, the communications manager 1020 may include a PDCCH skip inactivity timer manager 1025, a DCI manager 1030, a PDCCH skipping resume condition manager 1035, a capability information manager 1040, a PDCCH skip inactivity timer configuration manager 1045, a preferred parameter manager 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The PDCCH skip inactivity timer manager 1025 is capable of, configured to, or operable to support a means for transmitting an indication of a PDCCH skip inactivity timer. The DCI manager 1030 is capable of, configured to, or operable to support a means for transmitting a first downlink control information indicating that a UE is to perform PDCCH skipping for a first set of one or more slots and to monitor, for another downlink control information, a second set of one or more slots in accordance with the PDCCH skip inactivity timer, where an absence of the other downlink control information in the second set of one or more slots indicates a resumption of PDCCH skipping for a third set of one or more slots. In some examples, the second set of one or more slots are subsequent to the first set of one or more slots and the third set of one or more slots are subsequent to the second set of one or more slots.

In some examples, to support the first downlink control information indicating to initiate the PDCCH skip inactivity timer based on a detected PDCCH skipping resume condition, the PDCCH skipping resume condition manager 1035 is capable of, configured to, or operable to support a means for a downlink buffer status report (BSR) satisfying a first threshold quantity for a first threshold duration, an uplink BSR satisfying a second threshold quantity for a second threshold duration, or both.

In some examples, the first downlink control information indicates one or more of: a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

In some examples, the capability information manager 1040 is capable of, configured to, or operable to support a means for receiving capability information indicating one or more of: an indication that the UE supports the PDCCH skip inactivity timer, a preferred quantity of slots for the PDCCH skip inactivity timer, a preference for operating a C-DRX inactivity timer associated with a C-DRX active state during the second set of one or more slots defined by the PDCCH skip inactivity timer, or any combination thereof. In some examples, the PDCCH skip inactivity timer configuration manager 1045 is capable of, configured to, or operable to support a means for determining a configuration for the PDCCH skip inactivity timer based on the capability information.

In some examples, the preferred parameter manager 1050 is capable of, configured to, or operable to support a means for receiving an indication of one or more preferred parameters associated with the UE for the PDCCH skip inactivity timer, the one or more preferred parameters including a preferred quantity of slots for the PDCCH skip inactivity timer, a preferred threshold quantity of slots that the UE may perform PDCCH skipping for during a C-DRX active state, a preference for operating a C-DRX inactivity timer associated with the C-DRX active state during the second set of one or more slots, or any combination thereof. In some examples, the PDCCH skip inactivity timer configuration manager 1045 is capable of, configured to, or operable to support a means for determining a configuration for the PDCCH skip inactivity timer based on the one or more preferred parameters.

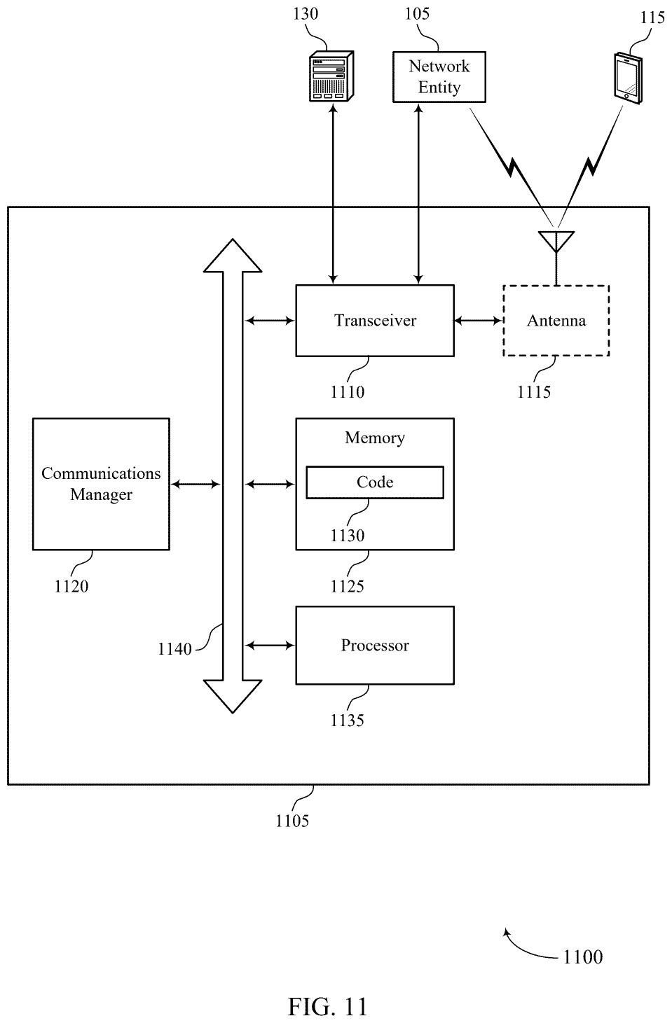

FIG. 11 shows a diagram of a system 1100 including a device 1105 that supports a PDCCH skip inactivity timer for resuming PDCCH monitoring skipping in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some aspects, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some aspects, the transceiver 1110 may include or be configured for coupling with one or more processors or one or more memory components that are operable to perform or support operations based on received or obtained information or signals, or to generate information or other signals for transmission or other outputting, or any combination thereof. In some aspects, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting PDCCH skip inactivity timer for resuming PDCCH monitoring skipping). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting an indication of a PDCCH skip inactivity timer. The communications manager 1120 is capable of, configured to, or operable to support a means for transmitting a first downlink control information indicating that a UE is to perform PDCCH skipping for a first set of one or more slots and to monitor, for another downlink control information, a second set of one or more slots in accordance with the PDCCH skip inactivity timer, where an absence of the other downlink control information in the second set of one or more slots indicates a resumption of PDCCH skipping for a third set of one or more slots. In some examples, to, the communications manager 1120 may be configured as or otherwise support a means for the second set of one or more slots being subsequent to the first set of one or more slots and the third set of one or more slots being subsequent to the second set of one or more slots.

By including or configuring the communications manager 1120 in accordance with examples as described herein, the device 1105 may support techniques for reduced latency and improved user experience related to reduced power consumption and more efficient utilization of communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of a PDCCH skip inactivity timer for resuming PDCCH monitoring skipping as described herein, or the at least one processor 1135 and the at least one memory 1125 may be otherwise configured to, individually or collectively, perform or support such operations.

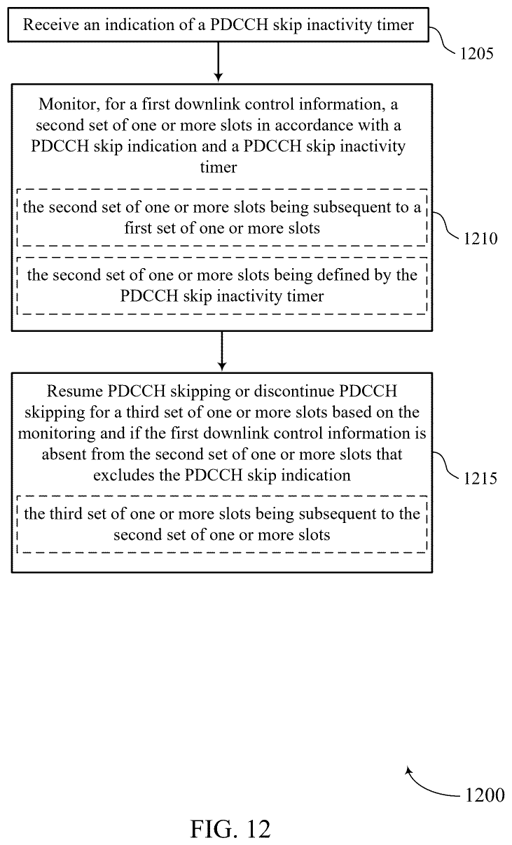

FIG. 12 shows a flowchart illustrating a method 1200 that supports a PDCCH skip inactivity timer for resuming PDCCH monitoring skipping in accordance with one or more aspects of the present disclosure. The operations of the method 1200 may be implemented by a UE or its components as described herein, such as the PDCCH skipping of FIGS. 2 and 3. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving an indication of a PDCCH skip inactivity timer. The operations of 1205 may be performed in accordance with examples as disclosed herein, such as in accordance with the reception of the indication of a PDCCH skip inactivity timer at 315 of FIG. 3. In some examples, aspects of the operations of 1205 may be performed by a PDCCH skip inactivity timer component 625 as described with reference to FIG. 6. Additionally, or alternatively, aspects of the operations of 1205 may be performed by the device 705 in association with the at least one processor 740 executing the code 735 stored in the at least one memory 730, as described with reference to FIG. 7.

At 1210, the method may include monitoring, for a first downlink control information, a second set of one or more slots in accordance with a PDCCH skip indication and a PDCCH skip inactivity timer. In some examples, may include the second set of one or more slots being subsequent to a first set of one or more slots and the second set of one or more slots being defined by the PDCCH skip inactivity timer. The operations of 1210 may be performed in accordance with examples as disclosed herein, such as in accordance with monitoring the second set of one or more slots at 335 of FIG. 3. The second set of one or more slots may be an example of the transition slots 250 of FIG. 2. In some examples, aspects of the operations of 1210 may be performed by a monitoring component 630 as described with reference to FIG. 6. Additionally, or alternatively, aspects of the operations of 1210 may be performed by the device 705 in association with the at least one processor 740 executing the code 735 stored in the at least one memory 730, as described with reference to FIG. 7.

At 1215, the method may include resuming PDCCH skipping or discontinuing PDCCH skipping for a third set of one or more slots based on the monitoring and if the first downlink control information is absent from the second set of one or more slots that excludes the PDCCH skip indication. In some examples, may include the third set of one or more slots being subsequent to the second set of one or more slots. The operations of 1215 may be performed in accordance with examples as disclosed herein, such as in accordance with monitoring a PDCCH on the third set of one or more slots at 345 of FIG. 3. The third set of one or more slots may be an example of the second subset of skipped slots 245-b of FIG. 2. In some examples, aspects of the operations of 1215 may be performed by a PDCCH skipping component 635 as described with reference to FIG. 6. Additionally, or alternatively, aspects of the operations of 1215 may be performed by the device 705 in association with the at least one processor 740 executing the code 735 stored in the at least one memory 730, as described with reference to FIG. 7.

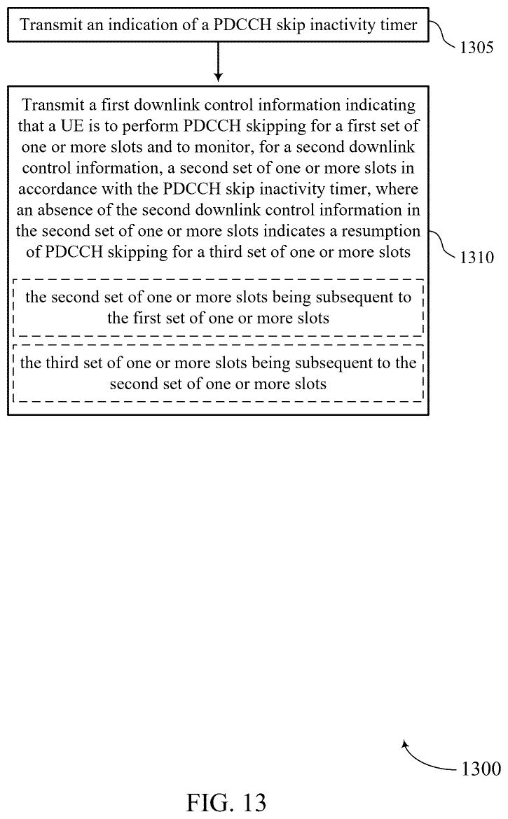

FIG. 13 shows a flowchart illustrating a method 1300 that supports a PDCCH skip inactivity timer for resuming PDCCH monitoring skipping in accordance with one or more aspects of the present disclosure. The operations of the method 1300 may be implemented by a network entity or its components as described herein, such as the PDCCH skipping of FIGS. 2 and 3. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include transmitting an indication of a PDCCH skip inactivity timer. The operations of 1305 may be performed in accordance with examples as disclosed herein, such as in accordance with transmitting the indication of a PDCCH skip inactivity timer at 315 of FIG. 3. In some examples, aspects of the operations of 1305 may be performed by a PDCCH skip inactivity timer manager 1025 as described with reference to FIG. 10. Additionally, or alternatively, aspects of the operations of 1305 may be performed by the device 1105 in association with the at least one processor 1135 executing the code 1130 stored in the at least one memory 1125, as described with reference to FIG. 11.

At 1310, the method may include transmitting a first downlink control information indicating that a UE is to perform PDCCH skipping for a first set of one or more slots and to monitor, for another downlink control information, a second set of one or more slots in accordance with the PDCCH skip inactivity timer, where an absence of the other downlink control information in the second set of one or more slots indicates a resumption of PDCCH skipping for a third set of one or more slots. In some examples, may include the second set of one or more slots being subsequent to the first set of one or more slots and the third set of one or more slots being subsequent to the second set of one or more slots. The operations of 1310 may be performed in accordance with examples as disclosed herein, such as in accordance with transmitting the first DCI at 330 of FIG. 3. The first DCI may be an example of the first DCI 240-a of FIG. 2. In some examples, aspects of the operations of 1310 may be performed by a DCI manager 1030 as described with reference to FIG. 10. Additionally, or alternatively, aspects of the operations of 1310 may be performed by the device 1105 in association with the at least one processor 1135 executing the code 1130 stored in the at least one memory 1125, as described with reference to FIG. 11.

The following provides an overview of aspects of the present disclosure:

Aspect 1: A method for wireless communications at a UE, comprising: receiving an indication of a PDCCH skip inactivity timer; monitoring, for a first DCI, a second set of one or more slots in accordance with a PDCCH skip indication and a PDCCH skip inactivity timer, the second set of one or more slots being subsequent to a first set of one or more slots, the second set of one or more slots being defined by the PDCCH skip inactivity timer; and resuming PDCCH skipping or discontinuing PDCCH skipping for a third set of one or more slots based at least in part on the monitoring and if the first DCI is absent from the second set of one or more slots that excludes the PDCCH skip indication, the third set of one or more slots being subsequent to the second set of one or more slots.

Aspect 2: The method of aspect 1, further comprising: monitoring a PDCCH on the third set of one or more slots for another DCI based at least in part on receiving the first DCI during the second set of one or more slots in accordance with the PDCCH skip inactivity timer, the first DCI comprising a scheduling grant and an indication for the UE to perform PDCCH skipping.

Aspect 3: The method of any of aspects 1 through 2, further comprising: transmitting capability information indicating one or more of: an indication that the UE supports the PDCCH skip inactivity timer, a preferred quantity of slots for the PDCCH skip inactivity timer, a preference for operating a C-DRX inactivity timer associated with a C-DRX active state during the second set of one or more slots defined by the PDCCH skip inactivity timer, or any combination thereof.

Aspect 4: The method of any of aspects 1 through 3, further comprising: transmitting an indication of one or more preferred parameters associated with the PDCCH skip inactivity timer based at least in part on receiving the indication of the PDCCH skip inactivity timer, the one or more preferred parameters including a preferred quantity of slots for the PDCCH skip inactivity timer, a preferred threshold quantity of slots that the UE may perform PDCCH skipping for during a C-DRX active state, a preference for operating a C-DRX inactivity timer associated with the C-DRX active state during the second set of one or more slots, or any combination thereof.

Aspect 5: The method of any of aspects 1 through 4, wherein the indication of the PDCCH skip inactivity timer comprises one or more of: a quantity of slots associated with the PDCCH skip inactivity timer, a threshold quantity of slots that the UE may resume performing PDCCH skipping for during a C-DRX active duration, or both.

Aspect 6: The method of any of aspects 1 through 5, further comprising: receiving another DCI indicating to perform PDCCH skipping for the first set of one or more slots and indicating to initiate the PDCCH skip inactivity timer in accordance with a PDCCH skipping resume condition.

Aspect 7: The method of aspect 6, wherein the other DCI indicates one or more of a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

Aspect 8: The method of any of aspects 6 through 7, wherein the PDCCH skipping resume condition comprises one or more of: a downlink BSR satisfying a first threshold quantity for a first threshold duration, an uplink BSR satisfying a second threshold quantity for a second threshold duration, or both.

Aspect 9: A method for wireless communications at a network entity, comprising: transmitting an indication of a PDCCH skip inactivity timer; and transmitting a first DCI indicating that a UE is to perform PDCCH skipping for a first set of one or more slots and to monitor, for another DCI, a second set of one or more slots in accordance with the PDCCH skip inactivity timer, wherein an absence of the other DCI in the second set of one or more slots indicates a resumption of PDCCH skipping for a third set of one or more slots, the second set of one or more slots being subsequent to the first set of one or more slots; and the third set of one or more slots being subsequent to the second set of one or more slots.

Aspect 10: The method of aspect 9, wherein the first DCI indicates to initiate the PDCCH skip inactivity timer based at least in part on a detected PDCCH skipping resume condition, wherein the detected PDCCH skipping resume condition comprises one or more of: a downlink BSR satisfying a first threshold quantity for a first threshold duration, an uplink BSR satisfying a second threshold quantity for a second threshold duration, or both.

Aspect 11: The method of aspect 10, wherein the first DCI indicates one or more of a C-DRX inactivity timer pause associated with a C-DRX active state during the second set of one or more slots, a C-DRX inactivity timer reset during the second set of one or more slots, or to continue running the C-DRX inactivity timer during the second set of one or more slots.

Aspect 12: The method of any of aspects 9 through 11, further comprising: receiving capability information indicating one or more of: an indication that the UE supports the PDCCH skip inactivity timer, a preferred quantity of slots for the PDCCH skip inactivity timer, a preference for operating a C-DRX inactivity timer associated with a C-DRX active state during the second set of one or more slots defined by the PDCCH skip inactivity timer, or any combination thereof; and determining a configuration for the PDCCH skip inactivity timer based at least in part on the capability information.

Aspect 13: The method of any of aspects 9 through 12, further comprising: receiving an indication of one or more preferred parameters associated with the UE for the PDCCH skip inactivity timer, the one or more preferred parameters including a preferred quantity of slots for the PDCCH skip inactivity timer, a preferred threshold quantity of slots that the UE may perform PDCCH skipping for during a C-DRX active state, a preference for operating a C-DRX inactivity timer associated with the C-DRX active state during the second set of one or more slots, or any combination thereof; and determining a configuration for the PDCCH skip inactivity timer based at least in part on the one or more preferred parameters.

Aspect 14: A UE for wireless communications, comprising one or more memories storing processor-executable code, and one or more processors coupled with the one or more memories and individually or collectively operable to execute the code to cause the UE to perform a method of any of aspects 1 through 8.

Aspect 15: A UE for wireless communications, comprising at least one means for performing a method of any of aspects 1 through 8.

Aspect 16: A non-transitory computer-readable medium storing code for wireless communications, the code comprising instructions executable by one or more processors to perform a method of any of aspects 1 through 8.

Aspect 17: A network entity for wireless communications, comprising one or more memories storing processor-executable code, and one or more processors coupled with the one or more memories and individually or collectively operable to execute the code to cause the network entity to perform a method of any of aspects 9 through 13.

Aspect 18: A network entity for wireless communications, comprising at least one means for performing a method of any of aspects 9 through 13.

Aspect 19: A non-transitory computer-readable medium storing code for wireless communications, the code comprising instructions executable by one or more processors to perform a method of any of aspects 9 through 13.

It should be noted that the methods described herein describe possible aspects or implementations. The operations and the steps may be rearranged or otherwise modified and other aspects or implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and aspects are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of a physical downlink control channel (PDCCH) skip inactivity timer;
monitor, for a first downlink control information, a second set of one or more slots in accordance with a PDCCH skip indication and a PDCCH skip inactivity timer,
the second set of one or more slots being subsequent to a first set of one or more slots, and
the second set of one or more slots being defined by the PDCCH skip inactivity timer; and
resuming PDCCH skipping or discontinuing PDCCH skipping for a third set of one or more slots based at least in part on the monitoring and if the first downlink control information is absent from the second set of one or more slots that excludes the PDCCH skip indication,
the third set of one or more slots being subsequent to the second set of one or more slots.

2. The UE of claim 1, wherein the one or more processors are individually or collectively further operable to execute the code to cause the UE to:
monitor a PDCCH on the third set of one or more slots for another downlink control information based at least in part on receiving the first downlink control information during the second set of one or more slots in accordance with the PDCCH skip inactivity timer, the first downlink control information comprising a scheduling grant and an indication for the UE to perform PDCCH skipping.

3. The UE of claim 1, wherein the one or more processors are individually or collectively further operable to execute the code to cause the UE to:
transmit capability information indicating one or more of: an indication that the UE supports the PDCCH skip inactivity timer, a preferred quantity of slots for the PDCCH skip inactivity timer, a preference for operating a connected-mode discontinuous reception (C-DRX) inactivity timer associated with a C-DRX active state during the second set of one or more slots defined by the PDCCH skip inactivity timer, or any combination thereof.

4. The UE of claim 1, wherein the one or more processors are individually or collectively further operable to execute the code to cause the UE to:
transmit an indication of one or more preferred parameters associated with the PDCCH skip inactivity timer based at least in part on receiving the indication of the PDCCH skip inactivity timer, the one or more preferred parameters including a preferred quantity of slots for the PDCCH skip inactivity timer, a preferred threshold quantity of slots that the UE may perform PDCCH skipping for during a connected-mode discontinuous reception (C-DRX) active state, a preference for operating a C-DRX inactivity timer associated with the C-DRX active state during the second set of one or more slots, or any combination thereof.

5. The UE of claim 1, wherein the indication of the PDCCH skip inactivity timer comprises one or more of: a quantity of slots associated with the PDCCH skip inactivity timer, a threshold quantity of slots that the UE may resume performing PDCCH skipping for during a connected-mode discontinuous reception (C-DRX) active duration, or both.

6. The UE of claim 1, wherein the one or more processors are individually or collectively further operable to execute the code to cause the UE to:
receive another downlink control information indicating to perform PDCCH skipping for the first set of one or more slots and indicating to initiate the PDCCH skip inactivity timer in accordance with a PDCCH skipping resume condition.

7. The UE of claim 6, wherein the other downlink control information indicates one or more of: a connected-mode discontinuous reception (C-DRX) inactivity timer pause associated with a C-DRX active state during the second set of one or more slots, a C-DRX inactivity timer reset during the second set of one or more slots, or to continue running the C-DRX inactivity timer during the second set of one or more slots.

8. The UE of claim 6, wherein the PDCCH skipping resume condition comprises one or more of: a downlink buffer status report (BSR) satisfying a first threshold quantity for a first threshold duration, an uplink BSR satisfying a second threshold quantity for a second threshold duration, or both.

9. A network entity, comprising:
one or more memories storing processor-executable code; and
one or more processors coupled with the one or more memories and individually or collectively operable to execute the code to cause the network entity to:
transmit an indication of a physical downlink control channel (PDCCH) skip inactivity timer; and
transmit a first downlink control information indicating that a user equipment (UE) is to perform PDCCH skipping for a first set of one or more slots and to monitor, for another downlink control information, a second set of one or more slots in accordance with the PDCCH skip inactivity timer, wherein an absence of the other downlink control information in the second set of one or more slots indicates a resumption of PDCCH skipping for a third set of one or more slots,
the second set of one or more slots be subsequent to the first set of one or more slots; and
the third set of one or more slots be subsequent to the second set of one or more slots.

10. The network entity of claim 9, wherein the first downlink control information indicates to initiate the PDCCH skip inactivity timer based at least in part on a detected PDCCH skipping resume condition, wherein the detected PDCCH skipping resume condition comprises one or more of:
a downlink buffer status report (BSR) satisfying a first threshold quantity for a first threshold duration, an uplink BSR satisfying a second threshold quantity for a second threshold duration, or both.

11. The network entity of claim 10, wherein the first downlink control information indicates one or more of: a connected-mode discontinuous reception (C-DRX) inactivity timer pause associated with a C-DRX active state during the second set of one or more slots, a C-DRX inactivity timer reset during the second set of one or more slots, or to continue running the C-DRX inactivity timer during the second set of one or more slots.

12. The network entity of claim 9, wherein the one or more processors are individually or collectively further operable to execute the code to cause the network entity to:
receive capability information indicating one or more of: an indication that the UE supports the PDCCH skip inactivity timer, a preferred quantity of slots for the PDCCH skip inactivity timer, a preference for operating a connected-mode discontinuous reception (C-DRX) inactivity timer associated with a C-DRX active state during the second set of one or more slots defined by the PDCCH skip inactivity timer, or any combination thereof; and
determine a configuration for the PDCCH skip inactivity timer based at least in part on the capability information.

13. The network entity of claim 9, wherein the one or more processors are individually or collectively further operable to execute the code to cause the network entity to:
receive an indication of one or more preferred parameters associated with the UE for the PDCCH skip inactivity timer, the one or more preferred parameters including a preferred quantity of slots for the PDCCH skip inactivity timer, a preferred threshold quantity of slots that the UE may perform PDCCH skipping for during a connected-mode discontinuous reception (C-DRX) active state, a preference for operating a C-DRX inactivity timer associated with the C-DRX active state during the second set of one or more slots, or any combination thereof; and
determine a configuration for the PDCCH skip inactivity timer based at least in part on the one or more preferred parameters.

14. A method for wireless communications at a user equipment (UE), comprising:
receiving an indication of a physical downlink control channel (PDCCH) skip inactivity timer;
monitoring, for a first downlink control information, a second set of one or more slots in accordance with a PDCCH skip indication and a PDCCH skip inactivity timer,
the second set of one or more slots being subsequent to a first set of one or more slots, and
the second set of one or more slots being defined by the PDCCH skip inactivity timer; and
resuming PDCCH skipping or discontinuing PDCCH skipping for a third set of one or more slots based at least in part on the monitoring and if the first downlink control information is absent from the second set of one or more slots that excludes the PDCCH skip indication,
the third set of one or more slots being subsequent to the second set of one or more slots.

15. The method of claim 14, further comprising:
monitoring a PDCCH on the third set of one or more slots for another downlink control information based at least in part on receiving the first downlink control information during the second set of one or more slots in accordance with the PDCCH skip inactivity timer, the first downlink control information comprising a scheduling grant and an indication for the UE to perform PDCCH skipping.

16. The method of claim 14, further comprising:
transmitting capability information indicating one or more of: an indication that the UE supports the PDCCH skip inactivity timer, a preferred quantity of slots for the PDCCH skip inactivity timer, a preference for operating a C-DRX inactivity timer associated with a C-DRX active state during the second set of one or more slots defined by the PDCCH skip inactivity timer, or any combination thereof.

17. The method of claim 14, further comprising:
transmitting an indication of one or more preferred parameters associated with the PDCCH skip inactivity timer based at least in part on receiving the indication of the PDCCH skip inactivity timer, the one or more preferred parameters including a preferred quantity of slots for the PDCCH skip inactivity timer, a preferred threshold quantity of slots that the UE may perform PDCCH skipping for during a connected-mode discontinuous reception (C-DRX) active state, a preference for operating a C-DRX inactivity timer associated with the C-DRX active state during the second set of one or more slots, or any combination thereof.

18. The method of claim 14, wherein the indication of the PDCCH skip inactivity timer comprises one or more of: a quantity of slots associated with the PDCCH skip inactivity timer, a threshold quantity of slots that the UE may resume performing PDCCH skipping for during a connected-mode discontinuous reception (C-DRX) active state, or both.

19. The method of claim 14, further comprising:
receiving another downlink control information indicating to perform PDCCH skipping for the first set of one or more slots and indicating to initiate the PDCCH skip inactivity timer in accordance with a PDCCH skipping resume condition.

20. The method of claim 19, wherein the other downlink control information indicates one or more of: a connected-mode discontinuous reception (C-DRX) inactivity timer pause associated with a C-DRX active state during the second set of one or more slots, a C-DRX inactivity timer reset during the second set of one or more slots, or to continue running the C-DRX inactivity timer during the second set of one or more slots.
